(19) United States
(12) Patent Application Publication
(10) Pub. No.: US 2007/0043833 A1
(43) Pub. Date: Feb. 22, 2007

(54) Computer platform system program remote upgrading control method and system

(75) Inventors: Ying-Chih Lu, Taipei (TW); Wen-Chian Chao, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/209,585

(22) Filed: Aug. 22, 2005

(51) Int. Cl. G06F 15/16

(52) U.S. Cl. 709/219

(57) ABSTRACT

A computer platform system program remote upgrading control method and system is proposed, which is designed for use with a network system for providing a local computer platform with a remote upgrading control capability, and which is characterized by the utilization of a specific network communication protocol, such as TCP/IP or UDP/IP, for a remote network workstation to send a copy of new-version BIOS program and a set of associated upgrading control commands in compliant with a specific interface protocol that is utilized on the server, such as IPMI-compliant commands, for the IPMI-equipped server to execute these IPMI-compliant upgrading control commands to perform an upgrading procedure on the BIOS module via an SMI handler. This feature allows server BIOS upgrading procedures to be more convenient to carry out than prior art

### BACKGROUND OF THE INVENTION

1. Field of the Invention

This invention relates to computer network technology, and more particularly, to a computer platform system program remote upgrading control method and system which is designed for use in conjunction with a network system linked to a computer platform, such as a network server, that is equipped with a system program module, such as a BIOS (Basic Input/Output System) module, for providing the server with a remote upgrading control capability that allows the BIOS module on the server to be upgraded through remote network control via a remote network workstation.

2. Description of Related Art

A network server is a network-linked computer platform that is permanently linked to a network system, such as Internet, an intranet system, an extranet system, or a LAN (Local Area Network) system, for providing network-based data services to client workstations that are also linked to the network system.

BIOS (Basic Input/Output System) is a widely used system program on network servers for providing an interface between the operating system and the various hardware components (including peripheral devices) installed on the server for the purpose of allowing the server to control the operations of these hardware components and peripheral devices through the operating system. In practice, BIOS programs are typically stored in a non-volatile programmable memory, such as flash memory. The use of flash memory for storing BIOS program allows network management personnel to conveniently upgrade the BIOS program in the flash memory. In practice, BIOS modules on servers not only include I/O related computer code, but also include some related business data such as the image file of an on-screen OEM logo, so that during the startup of the server, the OEM logo image can be displayed on screen for demonstration to the user.

In practical application, the BIOS modules on servers may need to be upgraded once in a while so as to allow the servers to operate on more powerful and stable BIOS programs or to display newly designed OEM logos on screen.

Presently, one method for upgrading BIOS programs on servers is to install a local control unit on the server and at the same time install a remote operating unit on the remote network workstation, where the local control unit operates under the operating system of the server, while the remote operating unit operates under the operating system of the remote network workstation. This distributed architecture allows remotely-located network management personnel to use the remote operating unit installed on his/her network workstation to gain access to the server via network system and activate the local control unit installed on the server to perform an BIOS upgrading procedure to the server.

One drawback to the aforementioned architecture, however, is that if the remote network workstation and the local server are based on different operating systems, for example the remote network workstation is based on Microsoft Windows XP while the server is based on Linux operating system, then the software implementation of the local control unit and the remote operating unit will take cross-platform capability into consideration, which would undesirably complicate the software development for the local control unit and the remote operating unit.

Moreover, another drawback to the aforementioned server BIOS upgrading method is that the upgrading procedure can be performed only after the local control unit installed on the server has been activated after the server has booted up with its operating system. In other words, the upgrading procedure cannot be activated right after BIOS POST (Power On Self Test) is completed but the operating system hasn't loaded yet. This drawback makes the upgrading procedure quite inconvenient.

### SUMMARY OF THE INVENTION

It is therefore an objective of this invention to provide a computer platform system program remote upgrading control method and system which allows a cross-platform capability to allow a remote network workstation with any operating system to perform a remotely-controlled BIOS upgrading procedure on a local server via network.

It is another objective of this invention to provide a computer platform system program remote upgrading control method and system which allows the BIOS upgrading procedure to be carried out after BIOS POST is completed without having to load the server operating system.

The computer platform system program remote upgrading control method and system according to the invention is designed for use in conjunction with a network system linked to a computer platform, such as a network server, that is equipped with a system program module, such as a BIOS (Basic Input/Output System) module, for providing the server with a remote upgrading control capability that allows the BIOS module on the server to be upgraded through remote network control via a remote network workstation.

The computer platform system program remote upgrading control method according to the invention comprises: (1) on the remote network workstation, prestoring a copy of new-version system program for the system program module on the local computer platform; (2) on the remote network workstation, responding to a user-initiated remote upgrading request event by issuing a remote upgrading enable message; (3) on the remote network workstation, responding to the remote upgrading enable message by generating a set of upgrading control commands in compliant with a specific interface protocol that is utilized on the local computer platform; (4) on the remote network workstation, transmitting the upgrading control commands via the network system to the local computer platform, where the upgrading control commands are processed by the platform management control unit via the system management interrupt handler for obtaining a set of upgrading control parameters from the system program module to be upgraded, and then transferring the obtained upgrading control parameters via the network system back to the remote network workstation; (5) on the remote network workstation, responding to the upgrading control parameters received via the network system from the local computer platform by retrieving a copy of the prestored new-version system program; and (6) on the remote network workstation, transmitting the retrieved new-version system program via the network system to the local computer platform to thereby activate the platform management control unit on the local computer platform to perform an upgrading procedure on the system program module via the system management interrupt handler.

In terms of architecture, the computer platform system program remote upgrading control system according to the invention comprises: (a) a remote side network communication module, which is capable of linking the remote network workstation via the network system to the local computer platform for the remote network workstation to communicate with the local computer platform via the network system; (b) a new-version system program storage module, which is used to prestore a copy of a new-version system program for the system program module on the local computer platform; (c) a user interface module, which is capable of responding to a user-initiated remote upgrading request event by issuing a remote upgrading enable message; (d) an upgrading control command generating module, which is capable of responding to the remote upgrading enable message from the user interface module by generating a set of upgrading control commands in compliant with a specific interface protocol that is utilized on the local computer platform, and which is capable of transmitting the upgrading control commands by means of the remote side network communication module and via the network system to the local computer platform, where the upgrading control commands are processed by the platform management control unit via the system management interrupt handler for obtaining a set of upgrading control parameters from the system program module and then transferring the obtained upgrading control parameters by means of the local side network communication module and via the network system back to the remote network workstation; and (e) a downloading module, which is capable of responding to the upgrading control parameters received via the network system from the local computer platform by retrieving a corresponding copy of new-version system program from the new-version system program storage module and activating the remote side network communication module to transmit the retrieved new-version system program via the network system to the local computer platform to thereby activate the platform management control unit on the local computer platform to perform an upgrading procedure on the system program module via the system management interrupt handler.

The computer platform system program remote upgrading control method and system according to the invention is characterized by the utilization of a specific network communication protocol, such as TCP/IP or UDP/IP, for a remote network workstation to send a copy of new-version BIOS program and a set of associated upgrading control commands in compliant with a specific interface protocol that is utilized on the server, such as IPMI-compliant commands, for the IPMI-equipped server to execute these IPMI-compliant upgrading control commands to perform an upgrading procedure on the BIOS module via an SMI handler. This feature allows a cross-platform capability to the remote network workstation and the local server, and also allows the BIOS upgrading procedure to be carried out after BIOS POST is completed without having to load the server operating system, and therefore allows the BIOS upgrading procedure to be more convenient to carry out than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application of the computer platform system program remote upgrading control system of the invention;

FIG. 2 is a schematic diagram showing the internal architecture of a server whose BIOS module can be upgraded by using the computer platform system program remote upgrading control system of the invention; and

FIG. 3 is a schematic diagram showing the object-oriented component model of the internal architecture of the computer platform system program remote upgrading control system of the invention.

### DETAILED DESCRIPTION OF PREFERRED EMBODIMENTS

The computer platform system program remote upgrading control method and system according to the invention is disclosed in full details by way of preferred embodiments in the following with reference to the accompanying drawings.

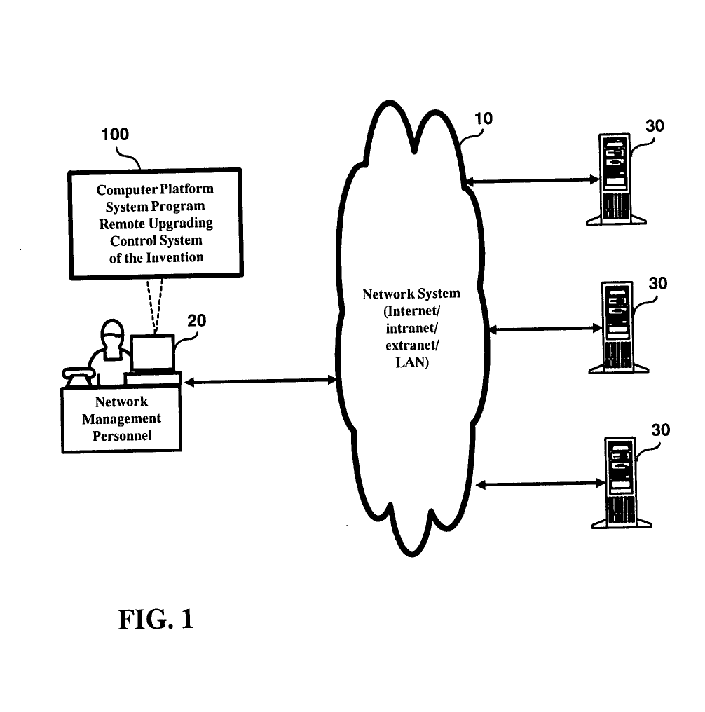

FIG. 1 is a schematic diagram showing the application of the computer platform system program remote upgrading control system of the invention 100. As shown, in practical application, the computer platform system program remote upgrading control system of the invention 100 is designed for installation on a remote network workstation 20 that is linked via a network system 10 to one or more local computer platforms, such as network servers 30, for providing the servers 30 with a remote upgrading control capability that allows the remote network workstation 20 to upgrade the program code of a system program module, such as a BIOS (Basic Input/Output System) module 60. In application, the contents of the BIOS module 60 that can be upgraded include input/output control code or related business data such as the image file of an on-screen OEM logo, to name a few.

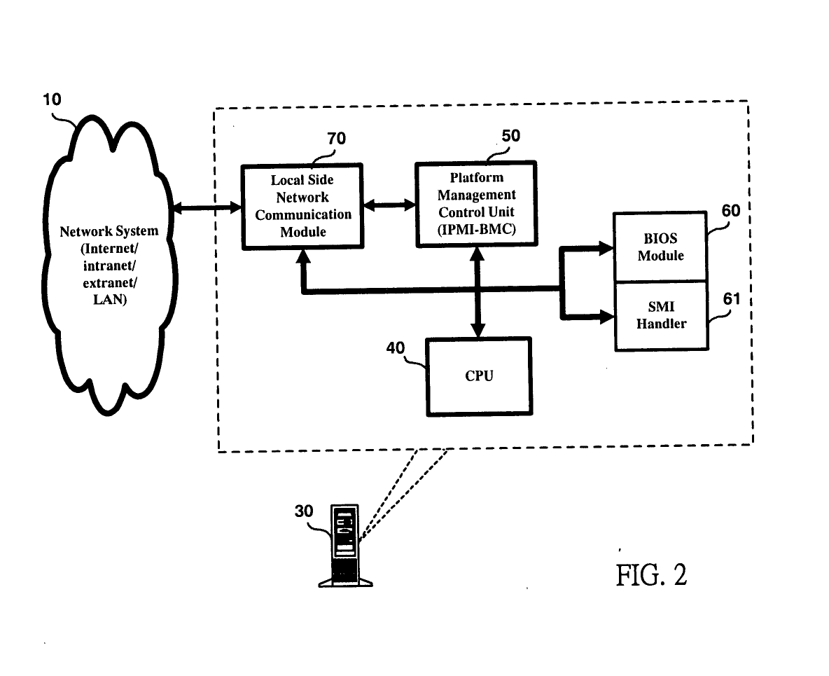

In practical implementation, for example, the computer platform system program remote upgrading control system of the invention 100 is applicable on any type of network system 10, such as Internet, an intranet system, an extranet system, a LAN (Local Area Network) system, or a combination thereof. Moreover, as shown in FIG. 2, in order to work with the remote upgrading control system of the invention 100, the server 30 should be equipped with the following components: (i) a CPU (Central Processing Unit) 40; (ii) a platform management control unit 50, such as a server-oriented BMC (Baseboard Management Controller) unit that is based on the standard IPMI (Intelligent Platform Management Interface) protocol,; (iii) a system program module 60, such as a BIOS (Basic Input/Output System), which is associated with an SMI (System Management Interrupt) handler 61; and (iv) a local side network communication module 70. Since IPMB, BMC, and SMI are well-known server or computer technologies in the information industry, detailed description thereof will not be given in this specification. The local side network communication module 70 is installed on the server 30, and which is used for linking the local server 30 via the network system 10 to the remote network workstation 20 for the local server 30 to communicate with the remote network workstation 20 via the network system 10. In practical implementation, for example, the local side network communication module 70 is based on an NIC (Network Interface Controller) unit that employs TCP/IP (Transmission Control Protocol/Internet Protocol) or UDP/IP (User Datagram Protocol/Internet Protocol) for network data communication with the remote network workstation 20 via the network system 10.

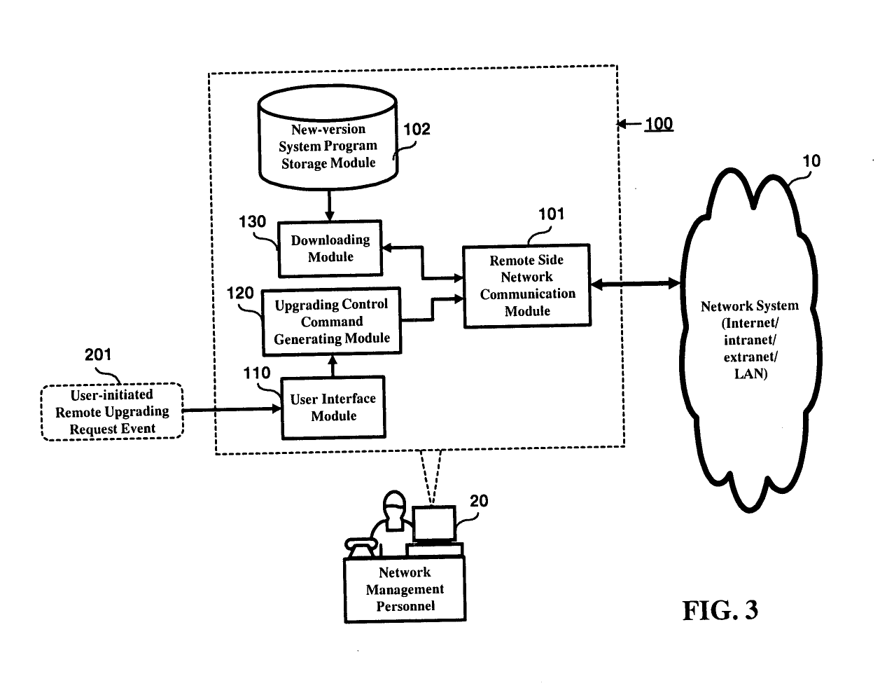

As shown in FIG. 3, the object-oriented component model of the computer platform system program remote upgrading control system of the invention 100 comprises: (a) a remote side network communication module 101; (b) a new-version system program storage module 102; (c) a user interface module 110; (d) an upgrading control command generating module 120; and (e) a downloading module 130. In practical implementation, for example, the remote upgrading control system of the invention 100 can be entirely realized by computer code which is integrated as an add-on software or firmware module to the operating system of the remote network workstation 20. The following will first describe the respective attributes and functions of the constituent modules 101, 102, 110, 120, 130 of the remote upgrading control system of the invention 100.

The remote side network communication module 101 is installed on the remote network workstation 20, and which is used for linking the remote network workstation 20 via the network system 10 to the server 30 for the remote network workstation 20 to communicate with the server 30 via the network system 10. In practical implementation, for example, this remote side network communication module 101 should be compliant in network communication protocol with the local side network communication module 70 on the local servers 30. In this embodiment, the remote side network communication module 101 is also based on an NIC unit that employs TCP/IP or UDP/IP for network data communication, and which utilizes the IP (Internet Protocol) address of the server 30 to link via the network system 10 to the server 30.

The new-version system program storage module 102 is used to allow the user (i.e., network management personnel) to prestore a copy of new-version BIOS program for the BIOS module 60 on each of the servers 30. Since the servers 30 may be different in models that need different BIOS programs, this new-version system program storage module 102 is capable of prestore a number of different BIOS programs that are respectively needed by the different models of the servers 30.

The user interface module 110 is capable of providing a user interface on the remote network workstation 20 for the user (i.e., network management personnel) to control the remote upgrading control system of the invention 100. In actual operation, this user interface module 110 is capable of responding to a user-initiated remote upgrading request event 201 by issuing a remote upgrading enable message to the upgrading control command generating module 120.

The upgrading control command generating module 120 is capable of responding to the remote upgrading enable message from the user interface module 110 by generating a set of upgrading control commands in compliant with a specific interface protocol that is utilized on the servers 30, such as IPMI (Intelligent Platform Management Interface) compliant commands, and which is then capable of transmitting the IPMI-compliant upgrading control commands by means of the remote side network communication module on TCP/IP or UDP/IP over the network system 10 to each of the servers 30 being upgraded. On the local side, the IPMI-compliant upgrading control commands will be processed by the IPMI-BMC platform management control unit 50 via the SMI handler 61 for obtaining a set of upgrading control parameters from the BIOS module 60, where the upgrading control parameters include, for example, the address range of the BIOS module 60, model of the server 30 being upgraded, and so on. The IPMI-BMC platform management control unit 50 is then capable of transferring the obtained upgrading control parameters by means of the local side network communication module 70 and via the network system 10 to the remote network workstation 20.

The downloading module 130 is capable of responding to the upgrading control parameters received via the network system 10 from each server 30 by retrieving a copy of new-version BIOS program from the new-version system program storage module 102 and then activating the remote side network communication module 101 to transmit the retrieved new-version BIOS program via the network system 10 to the server 30 being upgraded. When the server 30 receives the new-version BIOS program, it will activate the IPMI-BMC platform management control unit 50 to perform an upgrading procedure on the BIOS module 60 via the SMI handler 61.

In the following description of an example of a practical application of the invention, it is assumed that the network management personnel at the remote network workstation 20 wants to upgrade the BIOS program 60 in each of the servers 30.

Referring to FIG. 1 through FIG. 3 together, when the network management personnel wants to upgrade the BIOS module 60 in each of the servers 30, the first step is to load a copy of the new-version BIOS program into the new-version system program storage module 102 on the remote network workstation 20. Next, the network management personnel needs to activate the user interface module 110 and use it to initiate a remote upgrading request event 201, causing the user interface module 110 to respond by issuing a remote upgrading enable message to the upgrading control command generating module 120. In response, the upgrading control command generating module 120 generates a set of IPMI-compliant upgrading control commands, and then activates the remote side network communication module 101 to transmit the IPMI-compliant upgrading control commands in TCP/IP or UDP/IP data packets for transmission by TCP/IP or UDP/IP over the network system 10 to each of the servers 30 being upgraded.

On the local side, the local side network communication module 70 on each server 30 will receive and demodulate the TCP/IP or UDP/IP data packets to retrieve the original IPMI-compliant upgrading control commands, and then transfer the IPMI-compliant upgrading control commands to the IPMI-BMC platform management control unit 50. In response, the IPMI-BMC platform management control unit 50 processes these IPMI-compliant upgrading control commands via the SMI handler 61 for obtaining a set of upgrading control parameters from the BIOS module 60 to be upgraded, where the upgrading control parameters include, for example, the address range of the BIOS module 60, model of the server 30 being upgraded, and so on. The IPMI-BMC platform management control unit 50 then activates the local side network communication module 70 to transfer these upgrading control parameters via the network system 10 back to the remote network workstation 20.

On the remote network workstation 20, the remote side network communication module 101 will receive the upgrading control parameters via the network system 10 from the server 30 being upgraded, and then transfer these upgrading control parameters to the downloading module 130. In response, the downloading module 130 retrieves a corresponding copy of new-version BIOS program from the new-version system program storage module 102 based on the model of the server 30 to be upgraded (i.e., for different models of servers, different BIOS programs will be retrieved), and then activating the remote side network communication module 101 to transmit the binary stream of the retrieved new-version BIOS program on TCP/IP or UDP/IP via the network system 10 to each server 30 being upgraded. When the server 30 receives the new-version BIOS program, it will activate the IPMI-BMC platform management control unit 50 to perform an upgrading procedure on the BIOS module 60 via the SMI handler 61.

In conclusion, the invention provides a computer platform system program remote upgrading control method and system for use with a network system for providing a local computer platform with a remote upgrading control capability, and which is characterized by the utilization of a specific network communication protocol, such as TCP/IP or UDP/IP, for a remote network workstation to send a copy of new-version BIOS program and a set of associated upgrading control commands in compliant with a specific interface protocol that is utilized on the server, such as IPMI-compliant commands, for the IPMI-equipped server to execute these IPMI-compliant upgrading control commands to perform an upgrading procedure on the BIOS module via an SMI handler. This feature allows a cross-platform capability to the remote network workstation and the local server, and also allows the BIOS upgrading procedure to be carried out after BIOS POST is completed without having to load the server operating system, and therefore allows the BIOS upgrading procedure to be more convenient to carry out than prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer platform system program remote upgrading control method for use on a remote network workstation linked via a network system to a local computer platform that is equipped with a central processing unit, a platform management control unit, a system program module, a system management interrupt handler, and a local side network communication module for providing the local computer platform with a remote upgrading control capability that allows the program code of the system program module to be upgraded via the remote network workstation;
the computer platform system program remote upgrading control method comprising:
on the remote network workstation, prestoring a copy of new-version system program for the system program module on the local computer platform;
on the remote network workstation, responding to a user-initiated remote upgrading request event by issuing a remote upgrading enable message;
on the remote network workstation, responding to the remote upgrading enable message by generating a set of upgrading control commands in compliant with a specific interface protocol that is utilized on the local computer platform;
on the remote network workstation, transmitting the upgrading control commands via the network system to the local computer platform, where the upgrading control commands are processed by the platform management control unit via the system management interrupt handler for obtaining a set of upgrading control parameters from the system program module to be upgraded, and then transferring the obtained upgrading control parameters via the network system back to the remote network workstation;
on the remote network workstation, responding to the upgrading control parameters received via the network system from the local computer platform by retrieving a copy of the prestored new-version system program; and
on the remote network workstation, transmitting the retrieved new-version system program via the network system to the local computer platform to thereby activate the platform management control unit on the local computer platform to perform an upgrading procedure on the system program module via the system management interrupt handler.

2. The computer platform system program remote upgrading control method according to claim 1, wherein the computer platform is a network server.

3. The computer platform system program remote upgrading control method according to claim 1, wherein the network system includes Internet.

4. The computer platform system program remote upgrading control method according to claim 1, wherein the network system includes an intranet system.

5. The computer platform system program remote upgrading control method according to claim 1, wherein the network system includes an extranet system.

6. The computer platform system program remote upgrading control method according to claim 1, wherein the network system includes a LAN (Local Area Network) system.

7. The computer platform system program remote upgrading control method according to claim 1, wherein the upgrading control commands generated by the remote network workstation 20 are IPMI (Intelligent Platform Management Interface) compliant commands.

8. The computer platform system program remote upgrading control method according to claim 1, wherein the remote network workstation utilizes TCP/IP (Transmission Control Protocol/Internet Protocol) for network data communication with the local computer platform via the network system.

9. The computer platform system program remote upgrading control method according to claim 1, wherein the remote network workstation utilizes UDP/IP (User Datagram Protocol/Internet Protocol) for network data communication with the local computer platform via the network system.

10. A computer platform system program remote upgrading control system for use with a remote network workstation linked via a network system to a local computer platform that is equipped with a central processing unit, a platform management control unit, a system program module, a system management interrupt handler, and a local side network communication module for providing the local computer platform with a remote upgrading control capability that allows the program code of the system program module to be upgraded via the remote network workstation;
the computer platform system program remote upgrading control system comprising:
a remote side network communication module, which is capable of linking the remote network workstation via the network system to the local computer platform for the remote network workstation to communicate with the local computer platform via the network system;
a new-version system program storage module, which is used to prestore a copy of a new-version system program for the system program module on the local computer platform;
a user interface module, which is capable of responding to a user-initiated remote upgrading request event by issuing a remote upgrading enable message;
an upgrading control command generating module, which is capable of responding to the remote upgrading enable message from the user interface module by generating a set of upgrading control commands in compliant with a specific interface protocol that is utilized on the local computer platform, and which is capable of transmitting the upgrading control commands by means of the remote side network communication module and via the network system to the local computer platform, where the upgrading control commands are processed by the platform management control unit via the system management interrupt handler for obtaining a set of upgrading control parameters from the system program module and then transferring the obtained upgrading control parameters by means of the local side network communication module and via the network system back to the remote network workstation; and
a downloading module, which is capable of responding to the upgrading control parameters received via the network system from the local computer platform by retrieving a corresponding copy of new-version system program from the new-version system program storage module and activating the remote side network communication module to transmit the retrieved new-version system program via the network system to the local computer platform to thereby activate the platform management control unit on the local computer platform to perform an upgrading procedure on the system program module via the system management interrupt handler.

11. The computer platform system program remote upgrading control system according to claim 10, wherein the computer platform is a network server.

12. The computer platform system program remote upgrading control system according to claim 10, wherein the network system includes Internet.

13. The computer platform system program remote upgrading control system according to claim 10, wherein the network system includes an intranet system.

14. The computer platform system program remote upgrading control system according to claim 10, wherein the network system includes an extranet system.

15. The computer platform system program remote upgrading control system according to claim 10, wherein the network system includes a LAN (Local Area Network) system.

16. The computer platform system program remote upgrading control system according to claim 10, wherein the upgrading control commands generated by the remote system image downloading module are IPMI (Intelligent Platform Management Interface) compliant commands.

17. The computer platform system program remote upgrading control system according to claim 10, wherein the remote side network communication module utilizes TCP/IP (Transmission Control Protocol/Internet Protocol) for network data communication with the local computer platform via the network system.

18. The computer platform system program remote upgrading control system according to claim 10, wherein the remote side network communication module utilizes UDP/IP (User Datagram Protocol/Internet Protocol) for network data communication with the upgrading control parameter via the network system.
